(19) United States
(12) Patent Application Publication
(10) Pub. No.: US 2017/0060921 A1
(43) Pub. Date: Mar. 2, 2017

(54) INFORMATION PROCESSING SYSTEM AND COMPUTER PROGRAM

(71) Applicant: TURBO DATA LABORATORIES, INC., Kanagawa (JP)

(72) Inventor: Shinji Furusho, Kanagawa (JP)

(21) Appl. No.: 15/249,387

(22) Filed: Aug. 27, 2016

(30) Foreign Application Priority Data
Aug. 28, 2015 (JP) 2015-168925

(51) Int. Cl. G06F 17/30

(52) U.S. Cl. CPC G06F 17/30321; G06F 17/30339

(57) ABSTRACT

Row jumping is executed continuously at high speed, for sequentially presenting rows of records each having the same value being registered. Record numbers of a table are registered respectively in entries of SOS in an index, sorted by the values registered in the record, and data indicating a range of the entries in SOS is registered in ETRS, the range including record numbers of the records where the same value is registered. Rows of the record numbers where the value selected by a user is registered are determined as rows of target record numbers, referring to ETRS and SOS. Every time of forward jump operation, a row of the record number of the record to be presented is moved forward one row, among the rows of target record numbers.

### FIELD OF THE INVENTION

The present invention relates to a technique for displaying data in a table format.

### BACKGROUND OF THE INVENTION

As techniques for displaying data, there is known a technique that provides indexes such as B-tree and Hash, and by using those indexes, searches database for data and displays the data being retrieved (e.g., Japanese Unexamined Patent Application Publication No. 2007-25735, referred to as “patent document 1”, and Japanese Unexamined Patent Application Publication No. 6-335165, referred to as “patent document 2”).

A process so-called row jumping, switches a selected row to a row nearest forward or to a row nearest backward, on a displayed table including records in the form of rows, in response to a user's jump operation, among the rows of records (record rows) where the same value is registered as in the selected record row, and further highlights the selected row. When this row jumping is performed, every occurrence of user's jump operation, it is repeated to retrieve a record that registers the same value as in the selected record row, by using the indexes such as B-tree and Hash as described above, and to determine another record row nearest forward or nearest backward from thus retrieved record, so as to render the determined record row to be in the selected state in the displayed table. Due to such iteration of process steps, it is difficult to perform row jumping continuously at high speed.

In view of the foregoing problem, an object of the present invention is to execute the row jumping continuously at high speed, the row jumping sequentially presenting record rows where the same value is registered, in response to the user's jump operation, in the state where a table is being read out and displayed from a database which stores tables including records in the form of rows.

### BRIEF SUMMARY OF INVENTION

To achieve the object as described above, the present invention is directed to an information processing system for displaying a table having records in the form of rows, the record including one or plural fields, and the information processing system is provided with a storage that stores indexes provided respectively in association with the fields, and a row jump processor that presents records sequentially on a display of the table, in response to a jump operation by a user, each of the records having the same value in a specific field, as the value in the specific field of a specific record designated by the user on the display of the table. Each of the indexes in association with the fields is provided with, a list of sorted record numbers registering in an order of sorting record numbers that represent the order of records in the table, the records being sorted using the value in the corresponding field of the record as a first key, and using the record number as a second key, and range information indicating a range of ranks in the list of sorted record numbers, the record numbers of the records, each having the same value in the corresponding field, being registered in the range of ranks, as to each value used as the value in the corresponding field of the record in the table. The row jump processor is provided with a target record number setter, and a present record updater. The target record number setter refers to the range information of the index associated with the specific field of the specific record designated by the user, so as to obtain the range of ranks in the list of the sorted records, which registers the record numbers of the records having the same value in the associated field as the value in the specific field of the specific record designated by the user; and defines the rows of record numbers within thus obtained range of ranks in the list of sorted record numbers, as rows of target record numbers, along with setting as a target rank, a rank of the record number of the specific record designated by the user in the rows of target record numbers being defined. The record updater incrementing or decrementing the target rank by one, in the rows of target record numbers, every time of the jump operation by the user, and presenting the record on the display of the table, the record having the record number that is registered on the target rank in the rows of target record numbers.

To achieve the object as described above, the present invention is directed to an information processing system for displaying a union table obtained by combining plural tables having records in the form of rows, the record including one or plural fields, the information processing system is provided with a storage that stores index sets, respectively associated with the tables, and a row jump processor that presents records having the same value in a specific field, as the value in the specific field of a specific record designated by a user on a display of the table, sequentially on the display of the union table, in response to a jump operation by a user. The index set includes indexes, respectively provided for the fields in the table being associated. Each of the indexes that are respectively associated with the fields, is provided with a list of sorted record numbers, registering in an order of sorting, record numbers that represent the order of records in the table associated with the index set that includes the index, the records being sorted using the value in the corresponding field of the record as a first key, and using the record number as the second key, and range information indicating a range of ranks in the list of sorted record numbers, the record numbers of the records, each having the same value in the corresponding field, being registered in the range of ranks, as to each value used as the value of the corresponding field of the record of the table which is associated with the index set including the index. The row jump processor is provided with a target record number setter, and a present record updater. The target record number setter refers to the range information, as to each index associated with a specific field of the record designated by the user, in the index set associated with each table included in the union table being displayed, so as to obtain a range of ranks in the list of the sorted records registering the record numbers of the records having the same value in the associated field, as the value in the specific field in the specific record designated by the user, and defines the rows of record numbers within thus obtained range of ranks in the list of the sorted record numbers, as partial rows of target record numbers, and combines the partial rows of target records respectively provided for the indexes, in the same sequence as the sequence of the tables included in the union table, the partial rows being associated respectively with the index sets including the indexes, and obtaining rows of target record numbers, along with setting as a target rank, a rank of the record number of the specific record designated by the user, in the rows of target record numbers being combined. The record updater increments or decrements the target rank by one in the rows of target record numbers, every time of the jump operation by the user, and presents the record on the display of the union table, the record having the record number of the table associated with the index set including the index which is used for obtaining the partial rows including the record number on the target rank in the rows of target record numbers.

To achieve the object as described above, the present invention is directed to an information processing system for displaying a table having records in the form of rows, the record including one or plural fields, is provided with a storage that stores indexes provided respectively in association with the fields, and a row jump processor that presents records sequentially on a display of the table, in response to a jump operation by a user, the records having the same values in specific plural fields, as the values in the plural fields of a specific record designated by the user on the display of the table. Each of the indexes respectively associated with the fields is provided with a list of sorted record numbers, registering in an order of sorting record numbers that represent the order of records in the table, the records being sorted using the value in the corresponding field of the record as a first key, and using the record number as the second key, and range information indicating a range of ranks in the list of sorted record numbers, the record numbers of the records, each having the value in the corresponding field, being registered in the range of ranks, as to each value used as the value in the corresponding field of the record in the table. The row jump processor is provided with a target record number setter, and a present record updater. The target record number setter refers to the range information, as to each of the indexes associated with the specific plural fields designated by the user, so as to obtain a range of ranks in the list of the sorted records registering the record numbers of the records having the same values in the associated fields, as the values in the specific fields in the specific record designated by the user, defines the rows of record numbers within thus obtained range of ranks in the list of the sorted record numbers, as provisional rows of target record numbers, and obtains rows of target record numbers, by sorting the rows by the record numbers that are included commonly in all the provisional rows of target record numbers, respectively defined for the indexes, along with setting as a target rank, a rank of the record number of the specific record designated by the user, in the rows of target record numbers. The present record updater increments or decrements the target rank by one in the rows of target record numbers, every time of the jump operation by the user, and presents the record on the display of the table, the record having the record number that is registered on the target rank in the rows of target record numbers.

In the information processing system, the range information may include a value list and a pointer list. In the value list, a field value associated with a record of the table is registered in each of entries, and the pointer list has entries respectively corresponding to the entries of the value list. In each entry of the pointer list, a value that enables determination of an end rank of a range in the list of the sorted record numbers may be registered. In the range, registered is a record number of a record, of which value is registered in an entry of the value list, the entry corresponding to the entry of the value list.

According to the information processing system as described above, it is possible to acquire a row of target record numbers easily, which is a row of record numbers of records having the same value in a specific field, as the value in the specific field of the specific record designated by the user. Once the rows of target record numbers are acquired, a rank is incremented or decremented by one in the rows of target record numbers every time of jump operation, thereby allowing high-speed acquisition of the record number of a record to be presented next.

Accordingly, in response to the jump operation by the user, it is possible to perform the row jumping continuously at high speed, for presenting sequentially rows of records where the same value is registered.

As discussed above, according to the present invention, row jumping can be executed continuously at high speed for sequentially presenting rows of records where the same value is registered, in response to the jump operation by the user, in the state where a table is read out and displayed from a database that stores tables including records in the form of rows.

### BRIEF DESCRIPTION OF DRAWINGS

FIG. 1 is a block diagram showing a configuration of an information processing system according to a first embodiment of the present invention;

FIG. 2a and FIG. 2b illustrate the table data sets according to a first embodiment of the present invention;

FIGS. 3a1, 3a2, 3a3, 3b1, 3b2, 3c1, 3c2, and 3c3 illustrate examples of a row jumping according to the first embodiment of the present invention;

FIG. 4 is a flowchart showing the row jumping according to the first embodiment of the present invention;

FIGS. 5a, 5b, 5c, 5d, and 5e illustrate operations of the row jumping according to the first embodiment of the present invention;

FIGS. 6a, 6b, 6c, and 6d illustrate operations of a union-table row jumping according to the first embodiment of the present invention; and

FIGS. 7a, 7b, and 7c illustrate operations of the row jumping according to a second embodiment of the present invention.

### DESCRIPTION OF EMBODIMENTS

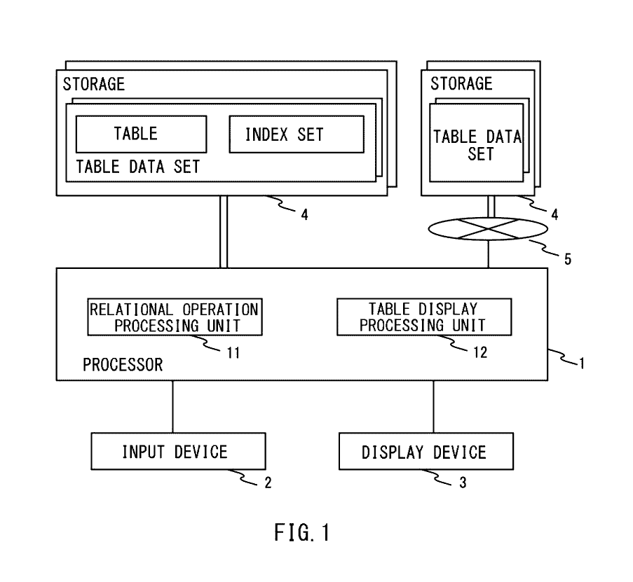

Embodiments of an information processing system according to the present invention will now be described. The first embodiment will be described. FIG. 1 shows a configuration of the information processing system according to the first embodiment. As illustrated, the information processing system comprises a processor 1, an input device 2, a display device 3, and one or more storage 4. The processor 1 further comprises a relational operation processing unit 11, and a table display processing unit 12. By way of example, the processor 1 is a general-purpose computer provided with a CPU, a memory, and various peripheral devices, and the relational operation processing unit 11 and the table display processing unit 12 are implemented as functions of the computer when the computer executes predetermined programs.

Next, the storage 4 stores a table of an RDB (Relational Database) and an index set which is a set of indexes, which are associated with the table. For the sake of convenience, the table and the index set are collectively referred to as a table data set, and each of the storage 4 stores one or more table data sets.

The storage 4 may be an external storage connected to the processor 1. It may also be network storage or a data server that the processor 1 accesses via the network 5. One table data set may be distributed in plural storages 4.

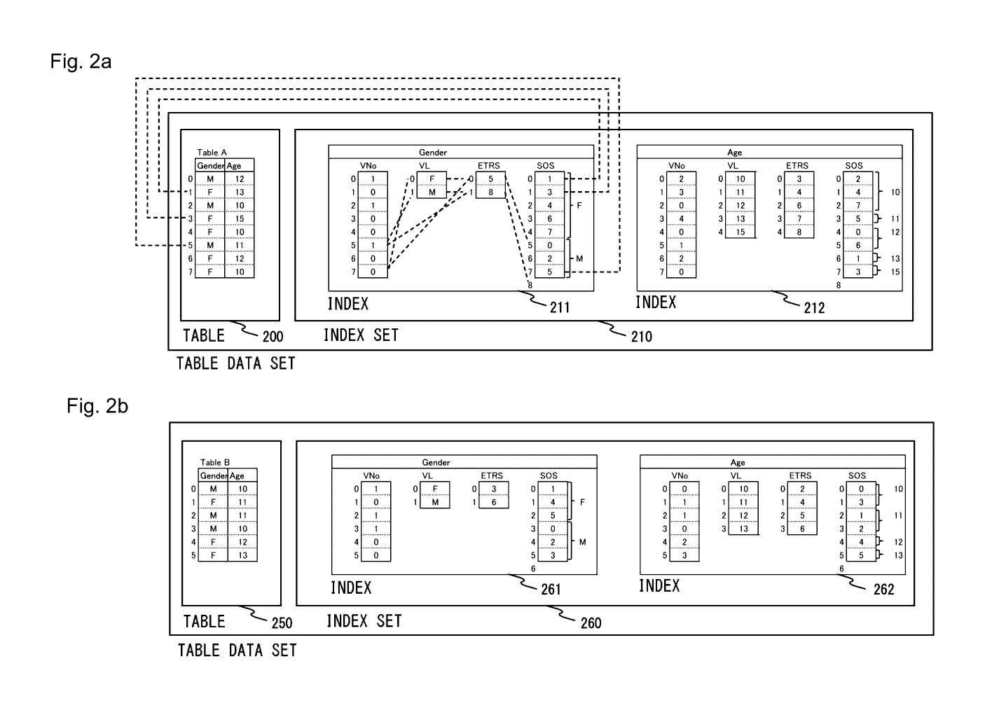

Next, FIGS. 2a and 2b illustrate the table data sets stored in each of the storage 4. FIG. 2a shows the table data set of Table A 200, and FIG. 2b shows the table data set of Table B 250. As illustrated, Table A 200 included in the table data set associated with Table A 200, is a table having records in the form of rows each including plural fields (“Gender” and “Age” in FIG. 2a), and in Table A 200, record numbers indicating the order of the rows of records (from zero to seven in FIG. 2a) are given to the records, respectively.

As shown in FIG. 2a, the index set 210 included in the table data set for Table A 200 comprises indexes provided respectively for the fields of the records in Table A 200. In FIG. 2a, there are “Gender” and “Age” as the fields of the records in Table A 200, and the “Gender” index 211 and the “Age” index 212 are included in the index set.

Similarly, as shown in FIG. 2b, the table data set for Table B 250 includes Table B 250 and the index set 260, and the index set 260 for Table B 250 includes the “Gender” index 261 and the “Age” index 262.

Each index comprises data items of VNo, VL, ETRS, and SOS (hereinafter, simply referred to as “VNo”, “VL”, “ETRS”, and “SOS”). VL is a list of values used as the field values in the corresponding table, the values being sorted according to prescribed criteria and respectively registered as entries. Byway of example, in the “Gender” index 211 in the index set 210 in the table data set for Table A 200 as shown in in FIG. 2a, VL is a list made up of an entry where “F” is registered and an entry where “M” is registered, since only “F” and “M” are registered in the field of “Gender” in Table A 200.

Next, VNo is a list of entries registering the same number of records as the records in the associated table. In the n-th entry in VNo, there is registered a value indicating a rank of the entries in VL, each entry in VL registering the field value associated with the record having the n-th record number in the corresponding table.

By way of example, the “Gender” index 211 in the index set 210 in the table data set for Table A 200 as shown in FIG. 2a, the value in the field “Gender” is “F”, as to the record having the record number “3” in Table A 200, and the rank of the entry in VL where “F” is registered is “0”. Therefore, “0” is registered in the third entry in VNo. Similarly, the value in the field “Gender” is “M”, as to the record having the record number “5” in Table A 200, and the rank of the entry where M is registered in VL is “1”. Accordingly, “1” is registered in the fifth entry in VNo.

Next, SOS is a list of entries registering the same number of records as the records in the associated table. In the entries of SOS, the record numbers of the respective records in the associated table are registered, in such a manner as sorted using as the first key, the rank of the entries in VL where field values associated with the records are registered, and using the record number as the second key. In other words, the record numbers of the records having, in the corresponding field, the values registered in the higher order entries in VL are registered in the higher order entries in SOS. Among the records having the same value in the corresponding field, the records having the smaller record numbers are registered in the higher order entries in SOS.

As for the index 211 of “Gender” in the index set 210 in the table data set for Table A 200 in FIG. 2a, the values in the field “Gender” are registered in the order of “F” and “M” in VL. Thus, the record numbers 1, 3, 4, 6, and 7 of the records having “F” as the value of the field “Gender” in Table A 200 are registered in the higher order entries in SOS, than the record numbers 0, 2, and 5, of the records having “M” as the value of the field “Gender”. In addition, the record numbers 1, 3, 4, 6, and 7 of the records having “F” as the field value of “Gender” are registered following the ascending order of the record numbers sequentially from the top entry to the subsequent entries in SOS. The record numbers 0, 2, and 5 having “M” as the field value of “Gender” are registered in SOS, following the ascending order of the record numbers, subsequent to the entries of the record numbers 1, 3, 4, 6, and 7 of the records having “F” as the field value of “Gender”.

Next, ETRS is provided with the same number of entries as the number of entries of VL. The value registered in each entry of ETRS indicates a rank next lower than the end rank in SOS of the entries within a range in SOS, the range registering the record numbers of the records in the corresponding table, where the record numbers are associated with the same field value in VL on the same rank as the rank in the ETRS.

For example, as for the “Gender” index 211 in the index set 210 included in the table data set for Table A 200 as shown in FIG. 2a, a record registered in the second entry of ETRS is “8”, since the rank at the bottom in the entries of SOS is “7” where the record numbers 0, 2, and 5 of the records have the value “M” in the field “Gender” in Table A 200, which is registered as the second entry in VL.

Accordingly, the value in the n-th entry in VNo represents the rank of the entry in VL where the field value is registered in association with the record having the record number n in the corresponding table, and also represents the rank of the entry in ETRS. The value in the n-th entry in VNo represents the rank of the entry in ETRS, and in the entry of ETRS on the rank, there is registered rank information indicating the next lower rank than the rank at the bottom in a range of the entries of SOS, the range including the record number of the record having the same field value as the field value of the record with the record number n in the corresponding table.

According to the index data as described above, the record number of the corresponding table enables acquiring a field value of the record having that record number, by using VNo and VL. In addition, according to VL, ETRS, and SOS, an associated field value in the corresponding table enables acquiring the number of records (record count) and the record numbers in the table, each holding the pertinent value in the associated field.

When a record number in the corresponding table is given, it is possible to obtain the record count and record numbers of records in the corresponding table, each having the same field and the same value therein, as the record with the given record number, by using VNo, VL, ETRS, and SOS.

Referring now to FIG. 1 again, the relational operation processing unit 11 in the processor 1 uses appropriately each index in the index data set as shown in FIGS. 2a and 2b, and performs record searching using as searching keys, the record number and the field value, and also performs processing for combining plural tables, such as JOIN and UNION.

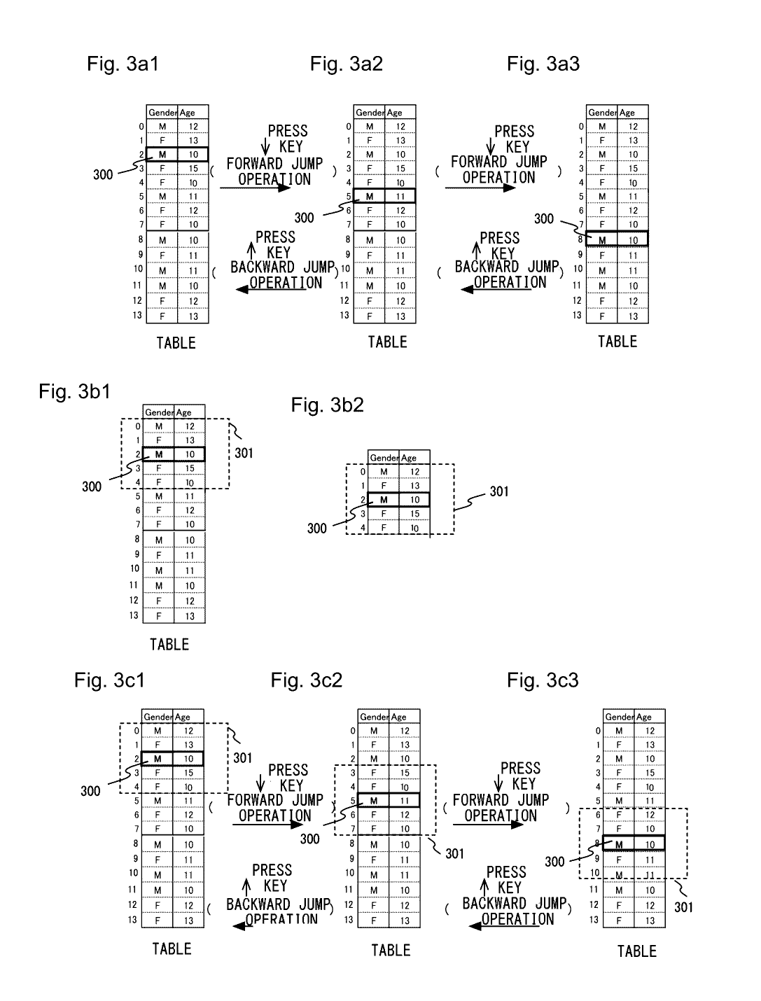

Meanwhile, the table display processing unit 12 in the processor 1 displays on the display device 3, a table (such as a table included in the table data set or a table generated via the combining process by the relational operation processing unit 11), which is designated by a user to display as shown in FIG. 3a1. The user uses the input device 2 to render the designated field to be in the selected state, and then, thus selected field and the row including the selected field are highlighted.

While a specific field of a specific row is in the selected state, along with highlighting the field 300 in the selected state and the row including the field 300, the table display processing unit 12 performs the row jumping when an operation to perform forward jumping or backward jumping is accepted from the user. By way of example, the forward jumping may be accepted by pressing the DownArrow key on the input device 2, and the backward jumping may be accepted by pressing the UpArrow key on the input device 2.

When the table display processing unit 12 accepts the user's operation to perform forward jumping, in the row jumping as shown in FIG. 3a1 to FIG. 3a2, and FIG. 3a2 to FIG. 3a3, the record being the nearest downward of the row including the selected field 300, among the records having the same value in the same field as the selected field 300, is updated as the field being selected, and then, the newly selected field and the row including the selected field are highlighted.

When the table display processing unit 12 accepts the user's operation to perform backward jumping, in the row jumping as shown in FIG. 3a3 to FIG. 3a2, and FIG. 3a2 to FIG. 3a1, a record being the nearest upward of the row including the selected field 300, among the records having the same value in the same field as the selected field 300, is updated as the field being selected, and then, this newly selected field and the row including the selected field are highlighted.

It is also possible to perform the row jumping as the following. That is, as shown in FIG. 3b1, the table display processing unit 12 of the processor 1 sets on the table being designated by the user for display, a range of displayed rows 301 that includes a certain number of rows, and as shown in FIG. 3b2, the table display processing unit 12 performs processing for displaying the range of displayed rows 301 on the display device 3. Additionally, the table display processing unit 12 moves the range of displayed rows 301 upwardly or downwardly, in response to the user's scrolling, and renders a field as selected, when the user designates the field via the input device 2, along with highlighting the selected field 300 and the row including the selected field 300.

While a specific field of a record of a specific row is selected and the selected field and the row including the field are highlighted, upon accepting the forward jumping according to the DownArrow key or the backward jumping according to the UpArrow key, the table display processing unit 12 performs the row jumping.

When the table display processing unit 12 accepts the forward jump operation from the user, in the row jumping as shown sequentially from FIG. 3c1 to FIG. 3c2, and from FIG. 3c2 to FIG. 3c3, a field of a record including the same value as the currently selected field 300 in the nearest downward row, among the records having the same value in the same field, is updated as the newly selected field 300. Then, the range of displayed rows 301 moves in such a manner that the newly selected field 300 is placed on the center row of the range, and the display on the display device 3 is updated so that the rows within thus updated range of displayed rows 301 are displayed. Thereafter, the selected field 300 and the row including the selected field 300 are displayed and highlighted.

When the table display processing unit 12 accepts the backward jump operation from the user, in the row jumping as shown sequentially from FIG. 3c3 to FIG. 3c2, and from FIG. 3c2 to FIG. 3c1, a field of a record including the same value as the currently selected field 300 in the nearest upward row, out of the records having the same value in the same field, is updated as the newly selected field 300. Then, the range of displayed rows 301 moves in such a manner that the newly selected field 300 is placed on the center row, and the display on the display device 3 is updated so that the rows within thus updated range of displayed rows 301 are displayed. Thereafter, the selected field 300 and the row including the selected field 300 are displayed and highlighted.

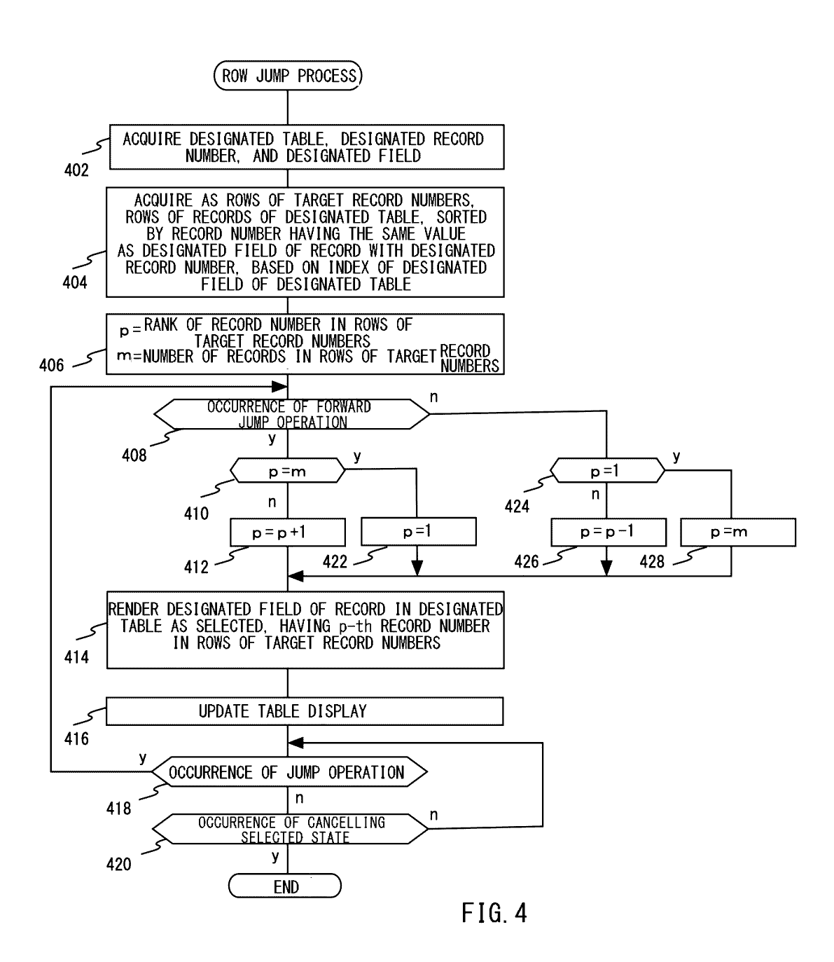

Details of the row jumping performed by the table display processing unit 12 will now be described. Firstly, there will be described the row jumping when a single table is displayed, among tables included in a table data set. FIG. 4 shows procedures of the row jumping when a single table is displayed, among the tables in the table data set. As illustrated, when a row jump operation occurs according to a user and the row jumping is started, the table display processing unit 12 acquires the table being displayed as the designated table, the record number of the record to which the selected field belongs, as the designated record number, and the selected field as the designated field (step 402). Next, with reference to the index of the designated field in the table data set associated with the designated table, records in the designated table, having the same value in the designated field as the value of the designated field of the record having the designated record number, are sorted by the record numbers. Then, the record numbers thus sorted are acquired as rows of target record numbers (step 404).

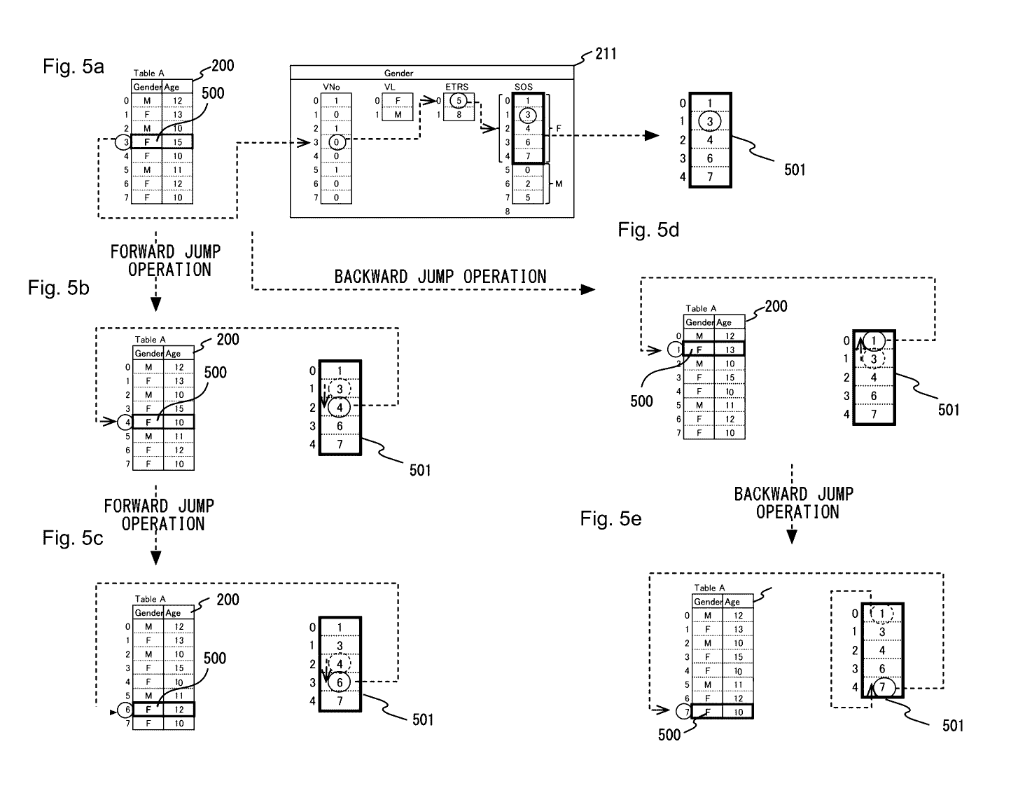

In step 404, the rows of target record numbers are acquired as the following. Assuming now that the designated table is Table A 200, the designated record number is “3”, and the designated field is “Gender”, as shown in FIG. 5a, the rows of target record numbers are acquired as the following. First, a rank “0” of ETRS, which is registered in an entry having a rank same as the designated record number “3” of VNo of index 211 of the Gender field (designated field) included in a table dataset of Table A 200 (designated table), is acquired. Then, a rank “5” (in SOS) which is registered in an entry of the thus acquired rank “0” of ETRS is acquired and a rank “4” before the rank “5” in SOS, is made to be an end rank, and a rank (in SOS) which is registered in an entry having a rank before the thus acquired rank of ETRS is made to be a start rank. If the acquired rank of ETRS is “0” as shown in FIG. 5A, however, “0” is made to be the start rank because no entry of ETRS exists before the “0” rank. A row of record numbers which are registered in the entries between an entry of the start rank “0” and an entry of the end rank “4” in SOS is made to be the row of target record numbers 501.

More specifically, the “Gender” field (designated field) is held in the storage as in the format of index 211 in the table data set associated with Table A 200 (designated table). Range information will be got by following steps.

1) Getting “0” from VNo array at rank 3 which is current record number of Table A. This value becomes the rank of ETRS array.
2) Accessing ETRS array at rank 0 which is obtained from VNo.
3) Checking a value obtained from VNo. If it is 0, that means lower bound of the target range of SOS is 0. This case, lower bound becomes 0.
4) Getting content of ETRS at rank 0, that is “5” which is upper bound+1. So, upper bound becomes 4.
5) Now, target range of SOS becomes [0, 4] that is shown in FIG. 5 as 501.

Next, when the rows of target record numbers are acquired (step 404), the record rank of the designated record number is assumed as “p” among the rows of target record numbers 501, and the number of records indicating the record numbers included in the rows of target record numbers 501, is assumed as “m” (step 406).

Then, it is checked whether the jump operation having occurred is the forward jump operation or the backward jump operation (step 408). In the case of the forward jump operation, it is checked whether p is equal to m, that is, the p-th record number in the rows of target record numbers 501 corresponds to the last record number of the rows of target record numbers 501 (step 410). If p is not equal to m, p is incremented by 1 (step 412), and the designated field of the record having the p-th record number in the rows of target record numbers 501 is updated as the selected field 500 (step 414).

Along with updating the selected field, the display is also updated (step 416). In step 416, as shown in FIGS. 3a1 to 3a3, the selected field and the row including the selected field which are to be highlighted, are updated, and as shown in FIGS. 3c1 to 3c3, the range of displayed rows and the selected field to be highlighted and the row including the selected field are updated.

Then, it is monitored whether the user performs another jump operation (step 418), or whether the currently selected field is canceled by the user, due to occurrence of selecting a field other than the currently selected field (step 420). When the user starts the new jump operation (step 418), processing restarts from the step 408.

When an operation to cancel the selected state of the field that has been selected (step 420), the row jumping is terminated. In step 410, when it is determined that p is equal to m, p is set to 1 (step 422), and the p-th record number in the rows of target record numbers 501, that is, the designated field of the record having the first record number in the rows of target record numbers 501 is updated as the selected field 500 (step 414), and displaying is also updated along with updating the selected field (step 416). Then, the process continues to the aforementioned step 418 and following steps.

When the jump operation in step 408 is not the forward jump operation, that is, when the jump operation that has occurred is determined as the backward jump operation, it is checked whether p is equal to 1, that is, the p-th record in the rows of target record numbers 501 is associated with the top record number of the rows of target record numbers 501 (step 424). If p is not equal to 1, p is decremented by 1 (step 426), and the designated field having the p-th record number in the rows of target record numbers 501 is updated as the selected field 500 (step 414), and the display is updated along with updating of the selected field (step 416). Then, the process continues to the aforementioned step 418 and following steps.

When p is equal to 1 (step 424), p is set to m (step 428), the designated field of the m-th record number in the rows of target record numbers 501, that is, the record having the last record number of the rows of target record numbers 501 is updated as the selected field 500 (step 414), and the display is also updated along with updating the selected field (step 416). Then, the process continues to the aforementioned step 418 and following steps.

So far, the row jumping has been described for the case where a single table included in the table data set is displayed. In the foregoing description, the rows of target record numbers are determined after the initial jump operation is performed by the user. It is alternatively possible to start determining the rows of target record numbers, at the point when a field becomes selected according to the user's designation.

According to the row jumping as described above, as shown in FIG. 5a, it is possible to easily acquire the rows of target record numbers 501 based on the record number of the record designated by the user, by using the index. Here, the rows of target record numbers 501 are rows of records sorted by the record number, the records having the same value in the field as the value of the field in the record designated by the user. As shown in FIG. 5a, once the rows of target record numbers 501 are acquired, it is easily retrieve and set the record number from the rows of target record numbers 501, in association with the record to which the selected field 500 belongs, just by performing the following procedures. That is, for the case of forward jump operation, as shown in FIG. 5b and FIG. 5c, the position of the record number to be retrieved from the rows of target record numbers 501 is moved forward one row. For the case of backward jump operation, as shown in FIG. 5d and FIG. 5e, the position of the record number to be retrieved from the rows of target record numbers 501 is moved backward one row.

If setting of the selected field is not performed cyclically, it is alternatively possible to configure the aforementioned row jumping as the following; when p is determined as equal to m in step 410, the process continues to the step 418, and when p is determined as equal to 1 in step 424, the process continues to the step 418.

Next, a table obtained by combining plural tables is referred to as a UNION table, those tables being included in different table data sets. There will be described the row jumping performed by the table display processing unit 12, when the union table is displayed.

The row jumping performed while the union table is displayed is similar to the row jumping as shown in FIG. 4, except the method of step 402 for acquiring a designated table, a designated record number, and a designated field, the method of step 404 for acquiring rows of target record numbers, and the step 414.

In other words, in the row jumping when the table display processing unit 12 displays the union table, the step 402, the step 404, and the step 414 are performed as the following. In step 402, a table to which a record including the selected field belongs, among the tables included in the displayed union table, is acquired as the designated table, a record number in the designated table, of the record to which the selected field belongs is acquired as the designated record number, and the selected field is acquired as the designated field.

Next in step 404, referring to the index of the designated field in the table data set for each table included in the union table, rows of record numbers sorted by the record number are acquired as partial rows of target record numbers. The thus acquired partial rows of target records are connected in the same order as the order of the corresponding tables in the union table to make the row of target record numbers.

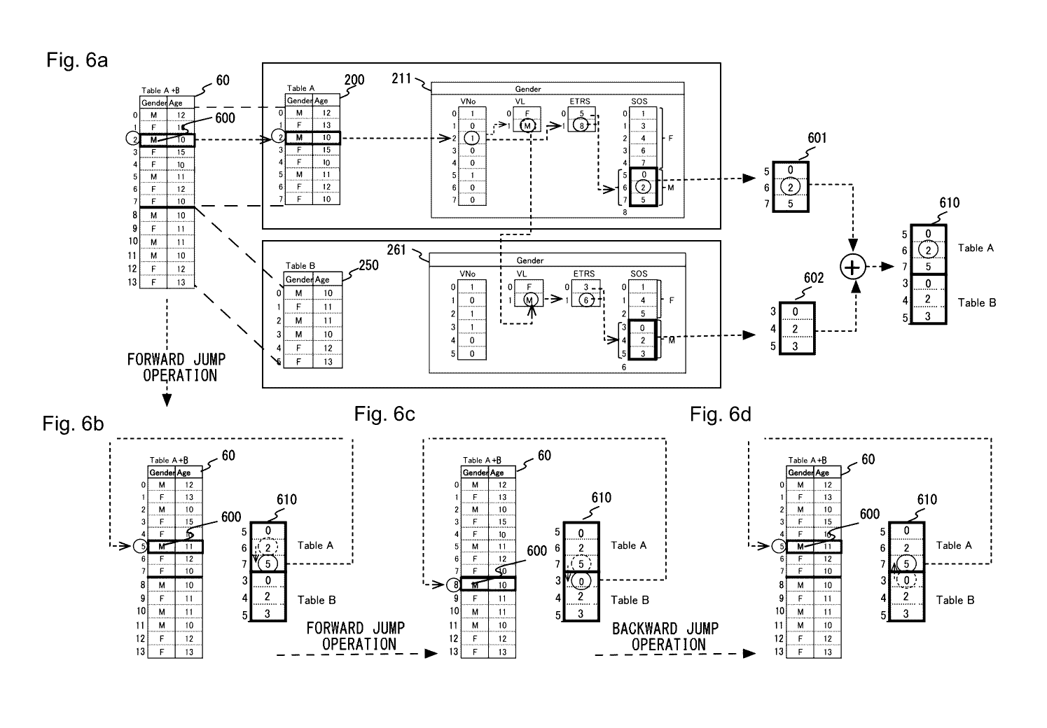

More specifically, in step 404, the rows of target record numbers are acquired as the following. As shown in FIG. 6a, the union table 60 is obtained by combining Table A 200 and Table B 250, in the sequence from Table A 200 to Table B 250. Table A 200 is the designated table to which the selected field 600 belongs. The case that the designated record number is “2”, and the designated field is “Gender” will be explained. First, a rank of ETRS, which is registered in an entry having a rank same as the design of VNo of index 211 of the Gender field (designated field) included in the table data set associated with Table A 200 (designated table), is acquired. Then, a rank (in SOS) preceding a rank that is registered in an entry of the thus acquired rank of ETRS is made to be an end rank, and a rank (in SOS) which is registered in an entry having a rank before the thus acquired rank of ETRS is made to be a start rank. A row of record numbers which are registered in the entries between an entry of the start rank and an entry of the end rank in SOS is made to be a partial row of target record numbers 601 of Table A 200.

Then, a rank of VL, which is registered in an entry having a rank same as the design of VNo of index 211 of the Gender field (designated field) included in the table data set associated with Table A 200 (designated table), is acquired. A value registered in an entry of the thus acquired rank of VL is obtained as a designated field value. Then, a rank of entry in which the designated field value of VL in index 261 of the Gender field (designated field) included in a table dataset of Table B 250, which is a table other than the designated table in the union table, is searched. A rank preceding a rank which is registered in an entry of ETRS having the same rank as the thus searched rank, is made to be an end rank, and a rank which is registered in an entry of ETRS having a rank before the thus searched rank is made to be a start rank. Then, a row of record numbers which are registered in the entries between an entry of the start rank and an entry of the end rank in SOS is made to be a partial row of target record numbers 602 of Table B 250.

Then, the partial rows of target record numbers 601 of Table A 200 and the partial rows of target record numbers 602 of Table B 250 are combined in accordance with the order of the tables in the union table, thereby obtaining the rows of target record numbers 610.

Next, in step 414 where the row jumping is performed when the union table is displayed, the designated field of the record, in the records of the union table is updated as the selected field, the record being associated with the p-th record number in the rows of target record numbers. Here, the record in the union table, being associated with the p-th record number in the rows of target record numbers, corresponds to the record having the record number in the table in association with the index used for determining the partial rows of target record numbers that include the p-th record number of the rows of target record numbers.

As described above, the partial target record rows are obtained by using the index, as to each table included in the union table, when the row jumping is performed on the union table, and the partial target record rows being obtained are combined to make the target record rows, thereby facilitating a setting of the rows of target record numbers. Once the rows of target record numbers are acquired, for the case of forward jump operation as shown in FIGS. 6b and 6c, the position of the record number to be retrieved from the rows of target record numbers 610 is moved forward one row. For the case of the backward jump operation, FIGS. 6c and 6d, the position of the record number to be retrieved from the rows of target record numbers 610 is moved backward one row. Accordingly, it is possible to easily retrieve and set the record number to which the selected field 600 belongs, from the rows of target record numbers 610.

The first embodiment of the present invention has been described so far. The second embodiment of the present invention will now be described. In the aforementioned first embodiment, when row jumping is performed, a single field designated by the user is rendered as selected, and the records having the same value in the same field as the selected field are presented sequentially in a highlighted manner or in any other manner. In the second embodiment, designation of plural fields is accepted from the user, and those plural fields thus designated are rendered as selected, and the records having the same values in the same fields as the selected fields are presented sequentially in a highlighted manner, or in any other manner.

The row jumping performed in the second embodiment is similar to the row jumping as shown in FIG. 4, except the method of step 402 for acquiring a designated table, a designated record number, and a designated field, and the method of step 404 for acquiring rows of target record numbers.

In the second embodiment, the table display processing unit 12 performs the processes in steps 402 and 404 as described below, in the row jumping when a single table included in the a table data set is displayed.

In step 402, a table being displayed is acquired as the designated table, a record number of the record to which the selected field belongs is acquired as the designated record number, and the fields being selected are acquired as designated fields.

Next in step 404, as to each index for each designated field in the table data set for the designated table, by referring to the index, rows of record numbers sorted by the record number are acquired as provisional rows of target record numbers. The record numbers are associated with the records having the same values as those in the designated fields. Then, intersection rows (a product set) of the provisional rows of target record numbers acquired respectively for the indexes are acquired as the rows of target record numbers.

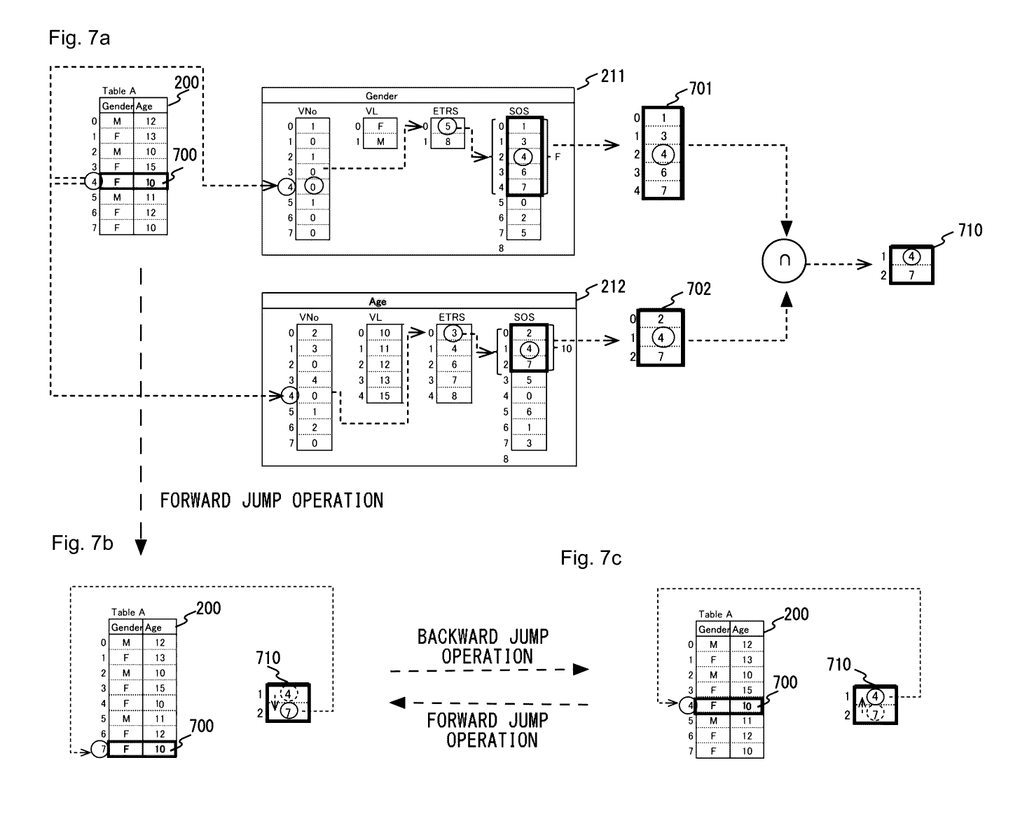

In step 404, the rows of target record numbers are acquired as the following. As shown in FIG. 7a, it is assumed that the designated table is table A 200, the designated record number is “4” and the designated fields are “Gender” and “Age”. In obtaining rows of target record numbers, range information in ETRS (ETRS-data) is acquired, registered in the entry on the record rank corresponding to the data in the entry in VNo in association with the designated record number, VNo being included in the index 211 of the “Gender” field (designated field) in the table set for Table A 200 (designated table). The range information obtained by decrementing by one the ETRS-data registered in the entry on the record rank is set as an end rank, and the ETRS-data registered in the entry on one rank higher than the record rank is set as a start rank, rows of the record numbers registered in the entries from the start rank to the end rank in SOS are set as the provisional rows of target record numbers 701.

Also for the other designated field “Age”, the range information in ETRS, registered in the entry on the record rank corresponding to the data in the entry in VNo associated with the designated record number is acquired, VNo being an index 212 of the “Age” field (designated field) included in the table set for Table A 200 (designated table). Then, the range information obtained by decrementing by one the ETRS-data registered in the entry on the record rank is set as an end rank, and the ETRS-data registered in the entry on one rank higher than the record rank is set as a start rank, rows of the record numbers registered in the entries from the start rank to the end rank in SOS are set as a provisional rows of target record numbers 702.

Subsequently, record numbers commonly included in both the two provisional rows of target record numbers 701 and 702, determined by using two designated fields “Gender” and “Age”, are extracted in the order of record numbers, so as to obtain rows of target record numbers 710.

As described above, when row jumping is performed involving plural fields, provisional rows of target records are obtained by using indexes respectively associated with the plural fields, and intersection rows (a product set) of thus obtained provisional rows of target records are set as the rows of target records. Accordingly, this facilitates setting of the rows of target record numbers also in the case of union table. Once the rows of target record numbers are acquired, for the case of forward jump operation as shown in FIGS. 7b and 7c, the position of the record number to be retrieved from the rows of target record numbers 710 is moved forward one row. For the case of the backward jump operation, the position of the record number to be retrieved from the rows of target record numbers 710 is moved backward one row. Accordingly, it is possible to easily retrieve and set the record number to which the selected field belongs, from the rows of target record numbers 710.

It is to be noted that when a union table is displayed, rows of target records can be obtained in row jumping involving plural fields similarly as shown in FIG. 7a. In this case, as to each designated field, the method of obtaining the rows of target record numbers of the union table as shown in 6a is performed, and thus obtained rows of target record numbers are used as the provisional rows of target record numbers for each designated field. Then, intersection rows (a product set) of those obtained provisional rows of target record numbers are set as the rows of target record numbers.

Embodiments of the present invention have been described so far. In each of the embodiments described above, updating the selected field is performed after the rows of target record numbers are obtained. If processing for determining the rows of target record numbers proceeds to a level enabling identification of the records that include the selected field, it is possible to update the selected field, without waiting until determination of the rows of target record numbers is completed.

For the case of determining the rows of target record numbers in the union table, obtaining partial rows of target record numbers and combining of partial rows of target record numbers with one another may be performed at a timing when the table is switched to another table to which a record including a field to be selected next belongs.

1. An information processing system for displaying a table having records in the form of rows, the record including one or plural fields, comprising,
a storage configured to store indexes provided respectively in association with the fields, and
a row jump processor configured to present records sequentially on a display of the table, in response to a jump operation by a user, each of the records having the same value in a specific field, as the value in the specific field of a specific record designated by the user on the display of the table, wherein,
each of the indexes in association with the fields comprises,
a list of sorted record numbers registering in an order of sorting record numbers that represent the order of records in the table, the records being sorted using the value in the corresponding field of the record as a first key, and using the record number as a second key, and
range information indicating a range of ranks in the list of sorted record numbers, the record numbers of the records, each having the same value in the corresponding field, being registered in the range of ranks, as to each value used as the value in the corresponding field of the record in the table, and
the row jump processor comprises,
a target record number setter and
a present record updater,
the target record number setter referring to the range information of the index associated with the specific field of the specific record designated by the user, so as to obtain the range of ranks in the list of the sorted records, which registers the record numbers of the records having the same value in the associated field as the value in the specific field of the specific record designated by the user; and defining the rows of record numbers within thus obtained range of ranks in the list of sorted record numbers, as rows of target record numbers, along with setting as a target rank, a rank of the record number of the specific record designated by the user in the rows of target record numbers being defined, and
the present record updater incrementing or decrementing the target rank by one, in the rows of target record numbers, every time of the jump operation by the user, and presenting the record on the display of the table, the record having the record number that is registered on the target rank in the rows of target record numbers.

2. An information processing system for displaying a union table obtained by combining plural tables having records in the form of rows, the record including one or plural fields, the information processing system comprising,
a storage configured to store index sets, respectively associated with the tables, and
a row jump processor configured to present records having the same value in a specific field, as the value in the specific field of a specific record designated by a user on a display of the table, sequentially on the display of the union table, in response to a jump operation by a user, wherein,
the index set includes indexes, respectively provided for the fields in the table being associated, and
each of the indexes that are respectively associated with the fields, comprises,
a list of sorted record numbers, registering in an order of sorting, record numbers that represent the order of records in the table associated with the index set that includes the index, the records being sorted using the value in the corresponding field of the record as a first key, and using the record number as the second key, and
range information indicating a range of ranks in the list of sorted record numbers, the record numbers of the records, each having the same value in the corresponding field, being registered in the range of ranks, as to each value used as the value of the corresponding field of the record of the table which is associated with the index set including the index, and
the row jump processor comprises,
a target record number setter, and
a present record updater,
the target record number setter referring to the range information, as to each index associated with a specific field of the record designated by the user, in the index set associated with each table included in the union table being displayed, so as to obtain a range of ranks in the list of the sorted records registering the record numbers of the records having the same value in the associated field, as the value in the specific field in the specific record designated by the user, and defining the rows of record numbers within thus obtained range of ranks in the list of the sorted record numbers, as partial rows of target record numbers, and combining the partial rows of target records respectively provided for the indexes, in the same sequence as the sequence of the tables included in the union table, the partial rows being associated respectively with the index sets including the indexes, and obtaining rows of target record numbers, along with setting as a target rank, a rank of the record number of the specific record designated by the user, in the rows of target record numbers being combined, and
the present record updater incrementing or decrementing the target rank by one in the rows of target record numbers, every time of the jump operation by the user, and presenting the record on the display of the union table, the record having the record number of the table associated with the index set including the index which is used for obtaining the partial rows including the record number on the target rank in the rows of target record numbers.

3. An information processing system for displaying a table having records in the form of rows, the record including one or plural fields, comprising,
a storage configured to store indexes provided respectively in association with the fields, and
a row jump processor configured to present records sequentially on a display of the table, in response to a jump operation by a user, the records having the same values in specific plural fields, as the values in the plural fields of a specific record designated by the user on the display of the table, wherein,
each of the indexes respectively associated with the fields comprising,
a list of sorted record numbers, registering in an order of sorting record numbers that represent the order of records in the table, the records being sorted using the value in the corresponding field of the record as a first key, and using the record number as the second key, and
range information indicating a range of ranks in the list of sorted record numbers, the record numbers of the records, each having the value in the corresponding field, being registered in the range of ranks, as to each value used as the value in the corresponding field of the record in the table, and
the row jump processor comprising,
a target record number setter, and
a present record updater,
the target record number setter referring to the range information, as to each of the indexes associated with the specific plural fields designated by the user, so as to obtain a range of ranks in the list of the sorted records registering the record numbers of the records having the same values in the associated fields, as the values in the specific fields in the specific record designated by the user, defining the rows of record numbers within thus obtained range of ranks in the list of the sorted record numbers, as provisional rows of target record numbers, and obtaining rows of target record numbers, by sorting the rows by the record numbers that are included commonly in all the provisional rows of target record numbers, respectively defined for the indexes, along with setting as a target rank, a rank of the record number of the specific record designated by the user, in the rows of target record numbers, and
the present record updater incrementing or decrementing the target rank by one in the rows of target record numbers, every time of the jump operation by the user, and presenting the record on the display of the table, the record having the record number that is registered on the target rank in the rows of target record numbers.

4. The information processing system according to claim 3, wherein,
the range information comprises a value list and a pointer list, the value list registering in each of entries, a value used as the value in the corresponding field of the record in the table and the pointer list including entries respectively associated with the entries of the value list, and
each entry in the pointer list registers a value that enables determination of an end rank of a range in the list of the sorted record numbers, the range including the record numbers of the records that register the same field value as in the associated entry of the value list.

5. A computer program that is readable and executable by a computer, wherein,
the computer program causes the computer to function as the information processing system according to claim 4.

6. A computer program that is readable and executable by a computer, wherein,
the computer program causes the computer to function as the information processing system according to claim 3.

7. A computer program that is readable and executable by a computer, wherein,
the computer program causes the computer to function as the information processing system according to claim 2.

8. A computer program that is readable and executable by a computer, wherein,
the computer program causes the computer to function as the information processing system according to claim 1.

9. The information processing system according to claim 2, wherein,
the range information comprises a value list and a pointer list, the value list registering in each of entries, a value used as the value in the corresponding field of the record in the table and the pointer list including entries respectively associated with the entries of the value list, and
each entry in the pointer list registers a value that enables determination of an end rank of a range in the list of the sorted record numbers, the range including the record numbers of the records that register the same field value as in the associated entry of the value list.

10. The information processing system according to claim 1, wherein,
the range information comprises a value list and a pointer list, the value list registering in each of entries, a value used as the value in the corresponding field of the record in the table and the pointer list including entries respectively associated with the entries of the value list, and
each entry in the pointer list registers a value that enables determination of an end rank of a range in the list of the sorted record numbers, the range including the record numbers of the records that register the same field value as in the associated entry of the value list.
